(19) United States
(12) Patent Application Publication
(10) Pub. No.: US 2017/0223608 A1
(43) Pub. Date: Aug. 3, 2017

(54) Method Performed in a Network Node For Classifying a Neighbour Cell and a Network Node

(71) Applicant: Telefonaktiebolaget LM Ericsson (publ), Stockholm (SE)

(72) Inventors: Parisa PAKNIAT, Norrköping (SE); Sven EKEMARK, Storvreta (SE); Daniel HENRIKSSON, Linköping (SE); Markus KELLER, Linköping (SE)

(73) Assignee: Telefonaktiebolaget LM Ericsson (publ), Stockholm (SE)

(21) Appl. No.: 15/127,456

(22) PCT Filed: Mar. 21, 2014
(86) PCT No.: PCT/SE2014/050349

§ 371 Date: Sep. 20, 2016

(51) Int. Cl. H04W 48/08; H04W 64/00; H04B 17/318; H04W 16/32; H04W 24/08

(52) U.S. Cl. CPC H04W 48/08; H04W 16/32; H04W 24/08; H04B 17/318; H04W 64/003; H04W 84/045

(57) ABSTRACT

The present disclosure relates to a method performed in a network node for classifying a neighbour cell. The method comprises the steps of obtaining (P1) from a plurality of wireless devices information related to a power level for a source cell and a power level for at least one neighbour cell, and determining (P5) whether the at least one neighbour cell is a small cell, based on the obtained information. The present disclosure further relates to such network node.

### TECHNICAL FIELD

The present disclosure relates to a method performed in a network node for classifying a neighbour cell.

The present disclosure also relates to a network node arranged to classify a neighbour cell.

### BACKGROUND

Small cells are low-powered radio access nodes. The small cells may have a range of 10 meters to 1 or 2 kilometers. The small cells are “small” compared to a mobile macro cell, which may have a range of a few tens of kilometers. Small cells encompass femtocells, picocells, and microcells. Small-cell networks can also be realized by means of distributed radio technology consisting of centralized baseband units and remote radio heads. Beamforming technology (focusing a radio signal on a very specific area) can be utilized to further enhance or focus small cell coverage.

With mobile operators struggling to support the growth in mobile data traffic' many are using Mobile data offloading as a more efficient use of radio spectrum. Small cells are a vital element to 3G data offloading, and many mobile network operators see small cells as vital to managing LTE Advanced spectrum more efficiently compared to using just macrocells.

Thus, it has been of increased interest to use multiple types of access nodes in wireless networks. The wireless network can use a mixture of small cells and macro cells, wherein the cells can be used on one or several frequency layers. It is a challenge to utilize the capacity of the small cells as much as possible.

### SUMMARY

In the existing technology, a source cell is not aware of whether its neighbor cells are macro cells or small cells.

The present disclosure relates to a method performed in a network node of classifying a neighbour cell. The method comprises the steps of obtaining from a plurality of wireless devices information related to a power level of a source cell and a power level of at least one neighbour cell, and determining whether one of the at least one neighbour cells is a small cell, based on the obtained information.

One advantage with this method is that identification of small neighbor cells of a macro cell is enabled. This classification of neighbor cell(s) can be used for different purposes which at the end may yield to improve and/or optimize network and/or wireless device performances. For example, inter-frequency load balancing between macro cell and small cells can be performed. Further, many small cell-specific solutions not available today can now be implemented in the network node.

Another advantage is that the identification of small cells can be made by the network node without any communications with other network nodes. Further, this can be made even in multi vendor networks. As the information related to the power level for the source cell and the power level for at least one neighbour cell is obtained by the network node from a plurality of wireless devices, the network node has access to the information used in the determination whether the at least one neighbor cell is a small cell.

In one option, the power level for the source cell and the at least one neighbour cell is a Reference Signal Received Power, RSRP. One advantage with using the RSRP is that the information related to the power level for the source cell and the power level for at least one neighbour cell is obtained from the wireless devices without any modification of the wireless devices.

In one option, the step of determining whether the neighbour cell is a small cell comprises determining a relation between the power levels for the neighbour cell and the power levels for the source cell. Thereby, if the neighbour cell is a small cell, this would be apparent from the relation between the power levels for the neighbour cell and the power levels for the source cell.

In one option, the method comprises a step of determining a power level distribution for the source cell and/or neighbour cell. The step of determining whether the at least one neighbour cell is a small cell is based on the power level distribution for the source cell and/or neighbour cell. Characteristically, the power level distribution as obtained from the wireless devices for a small neighbour cell would vary within a larger range than the power level distribution as obtained from the wireless devices for a macro neighbour cell within a geographical area equivalent to a typical coverage area of a small cell.

In one option, the step of determining whether the at least one neighbour cell is a small cell is based on a determination about whether the power level distribution for the source cell and/or neighbour cell is within a predetermined range.

In one option, the method comprises a step of determining a subset of wireless devices for which a measure related to the power level for the at least one neighbour cell exceeds the predetermined value. In accordance with this option, the step of determining whether the at least one neighbour cell is a small cell is based on the power level distribution for the source cell and/or neighbour cell within the subset of wireless devices. One advantage of this is that less relevant measurements for determining whether the at least one neighbour cell is a small cell are left out.

In one option, the step of determining a subset of wireless devices for which the measure related to the power level for the at least one neighbour cell exceeds a predetermined value comprises identifying wireless devices for which the neighbour cell power level exceeds the predetermined value. In this option, only measurements which indicate that a hand-over would be considerable are taken into account in the determination whether the at least one neighbour cell is a small cell.

In one option, the method comprises a step of obtaining a distance between the neighbour cell and a centre of the source cell. In this option, the determination whether one predetermined neighbour cell is a small cell is based on the determined distance between the neighbour cell and the centre of the source cell. By introducing the distance between the neighbour cell and the centre of the source cell for the respective wireless devices in the determination of whether the at least one neighbour cell is a small cell the accuracy in the determination can be improved. The difference between the distances for the respective wireless device gives an indication about the extension of the neighbour cell.

In one option, wherein the method comprises a the step of obtaining a distance between the neighbour cell and a centre of the source cell and the determination whether one predetermined neighbour cell is a small cell is based on the information related to a distance between the neighbour cell and a centre of the source cell, the predetermined range is dependent on the information related to the distance between the neighbour cell and the centre of the source cell. Thereby the accuracy of the predetermined range can be improved.

In one option, the information related to the distance between the neighbour cell and a centre of the source cell is based on the power level values for the source cell and/or the neighbour cell. Thereby, no additional information is required for obtaining the distance.

In one option, the information related to the distance between the neighbour cell and a centre of the source cell is based on an average power level value for the source cell and/or the neighbour cell for the subset of wireless devices. The determination of the average power level provides a simple way of determining the distance.

In one option, the step of obtaining a distance between the neighbour cell and a centre of the source cell comprises determining a distance value for each of a plurality of wireless devices. The determination of whether the at least one neighbour cell is a small cell is based on a spread in the distance values. This can improve the accuracy in the determination.

In one option, the step of obtaining P1 information related to the source cell and the at least one neighbour cell comprises obtaining from the plurality of wireless devices information related to a distance to the wireless device, wherein the step of determining whether one predetermined neighbour cell is a small cell is based on the provided information related to the distance to the wireless device. In using this information, the accuracy in the information can be improved.

In one option, the information related to the distance to the wireless device is a time advance, TA, value.

In one option, the step of determining whether one predetermined neighbour cell is a small cell is initiated upon obtaining, from a predetermined number of wireless devices, the information related to the source cell and to the at least one neighbour cell.

In one option, the method comprises a step of evaluating the obtained information related to the source cell and to the at least one neighbour cell. The step of determining whether one predetermined neighbour cell is a small cell is then initiated if the evaluation indicates that a certain amount of information for determining whether one predetermined neighbour cell is a small cell has been obtained.

In one option, the method further comprises a step of storing the obtained information in a memory.

One embodiment of the present disclosure relates to a network node arranged to classify a neighbour cell. The network node comprises a receiver and a control element. The control element comprises an information obtaining element arranged to obtain, using the receiver, from a plurality of wireless devices information related to a power level of a source cell and a power level of at least one neighbour cell. The control element further comprises a determining element arranged to determine whether one of the at least one neighbour cells is a small cell, based on the information obtained by the information obtaining element.

In one option, the power level for at least one of the source cell and the at least one neighbour cell is a Reference Signal Received Power, RSRP.

In one option, the determining element is arranged to determine whether the neighbour cell is a small cell or not based on a relation between the power levels for the predetermined neighbour cell and the power levels for the source cell.

In one option, the receiver is arranged to receive the information obtained from a plurality of wireless devices related to a source cell and at least one neighbour cell.

In one option, the memory is arranged to store the information obtained from a plurality of wireless devices related to a source cell and at least one neighbour cell.

In one option, the network node is a EUTRA Node-B, eNB.

In one option, the network node is a Radio Network Controller, RNC.

One embodiment of the present disclosure relates to a computer program for executing the steps of the method in a network node for classifying a neighbour cell according to the above.

### BRIEF DESCRIPTION OF THE DRAWINGS

FIG. 1 is a schematic overview of a source cell and a neighbour cell.

FIG. 2 is a diagram illustrating an example of source and neighbour cell power levels within the source cell.

FIG. 3 is a diagram illustrating a second example of source and neighbour cell power levels within the source cell.

FIG. 4 is a signal chart illustrating the signalling within a wireless device within a source cell.

FIG. 5 is a flow chart illustrating an example of a process for performing cell type determination.

FIG. 6 is a block scheme illustrating an example of a network node.

FIG. 7 is a table illustrating an example of information stored in a memory in a network node.

### DETAILED DESCRIPTION

The examples in this disclosure relate to an example with EUTRAN cells but the idea can be extended and used for other Radio Access Technologies, RATs as well.

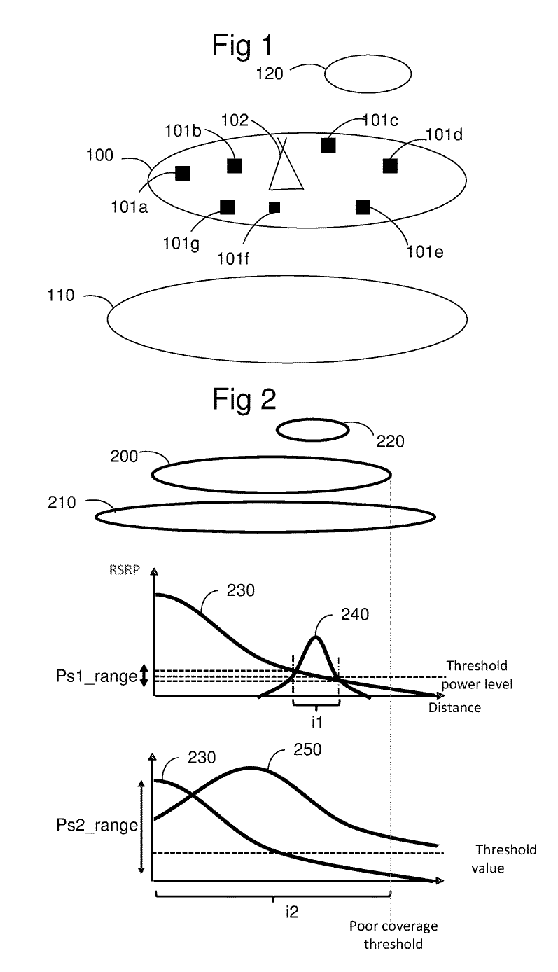

In FIG. 1, a system for signalling in a network is illustrated. In the illustrated example, signalling is performed between a UMTS Terrestrial Radio Access, EUTRA, Node-B, eNB, 102 and User Equipments, UE, 101a, 101b, 101c, 101d, 101e, 101f, 101g in an Evolved UMTS Terrestrial Radio Access Network. The UEs are connected to a source cell 100. The source cell is a macro cell. A macrocell is a cell in a mobile phone network that provides radio coverage served by a high power cellular base station (tower). Generally, macrocells provide coverage larger than small cell. The antenna for macro cells are for example mounted on ground-based masts, rooftops and other existing structures, at a height that provides a clear view over the surrounding buildings and terrain. In the illustrated example, two neighbouring cells are shown. A first neighbour cell 110 is a macro cell. A second neighbour cell is a small cell 120. In this disclosure, a small cell is a cell that has a shorter reach than a macro cell. In this disclosure the term small cell is used even though other terms can be used, such as pico cell.

The eNB 102 obtains from a plurality of UEs information related to the source cell and at least one neighbour cell. The information comprises information related to a power level of the source cell and a power level of the at least one neighbour cell. The eNB 102 determines whether one predetermined neighbour cell is a small cell or not, based on the obtained information related to the power level for the source cell and the power level for the at least one neighbour cell.

The UEs 101a, 101b, 101c, 101d, 101e, 101f, 101 are arranged to perform measurements to provide the power level of the source cell and of the at least one neighbour cell. The measurements are in one example ongoing on a number of UEs randomly selected in the source cell to provide the power levels. The measurements are for example performed on one or a plurality of neighbour frequencies. The measurements are in one example performed using any Radio Access Technology, RAT. If there are already existing useful measurements, these measurements can be reused. In one example, background measurements are made. The background measurements are for example of type A4. In one example, event measurements on neighbor received power are made. This measurement includes in one example the source received power as well. The information related to the measured power level of the source cell and the at least one neighbour cell is, as is apparent from the above, transmitted to the eNB 102.

In FIG. 4, an example of the signaling between a UE 401 and an eNB 402 when executing the proposed method for classifying a neighbour cell is illustrated. Those small cells whose coverage area is part of the coverage area of the source cell are identified.

The information that a neighbour cell is a small cell can be used to improve both network and UE performances by applying specific rules when knowing the neighbor cell is a small cell.

In the scheme of FIG. 4, the eNB obtains P1 from a plurality of wireless devices information related to a power level for a source cell and a power level for at least one neighbour cell, and determines P5 whether the at least one neighbour cell is a small cell, based on the obtained information. The power level for the source cell and the at least one neighbour cell is in one example a Reference Signal Received Power, RSRP.

For example, the eNB 402 selects P0 a plurality of wireless devices for measurement. The selection is in one example made randomly. Further, the eNB 402 orders Si1 measurements from the UE 401. The UE 401 then responds with reporting Sit information related to a power level for both source cell and neighbour cell(s). The power level for the source cell and the power level for the neighbour cell(s) are then obtained P1 in the eNB. In an optional step, the eNB 402 stores P3 the obtained information related to the power levels of the source cell and the neighbour cell(s).

In one example, the measurement report Sit from the UE 401 comprises also a timing advance, TA, value from the source cell. The TA value is one example also obtained P2. The TA value is in one example stored P3 along with the information related to the power level for the source cell and for the neighbour cell(s).

When the stored measurements have reached a certain amount, a cell type evaluation is performed to determine P5 whether the at least one neighbour cell is a small cell. In one example, the step of determining whether the at least one neighbour cell is a small cell is initiated upon obtaining, from a predetermined number of wireless devices, the information related to the source cell and to the at least one neighbour cell. In one example, an evaluation P4 of the measurements is made. The evaluation results in a decision whether the step P5 of determining whether the at least one neighbour cell is a small cell, is to be performed. In one example, the evaluation is made to decide whether a certain amount of measurements are obtained. If not, the process is in one example stopped until the certain amount of measurements is stored. In an alternative example, the process goes back to the step of order Si1 measurements.

If the certain amount of measurements have been reached, the cell type evaluation is performed to determine P5 whether the at least one neighbour cell is a small cell.

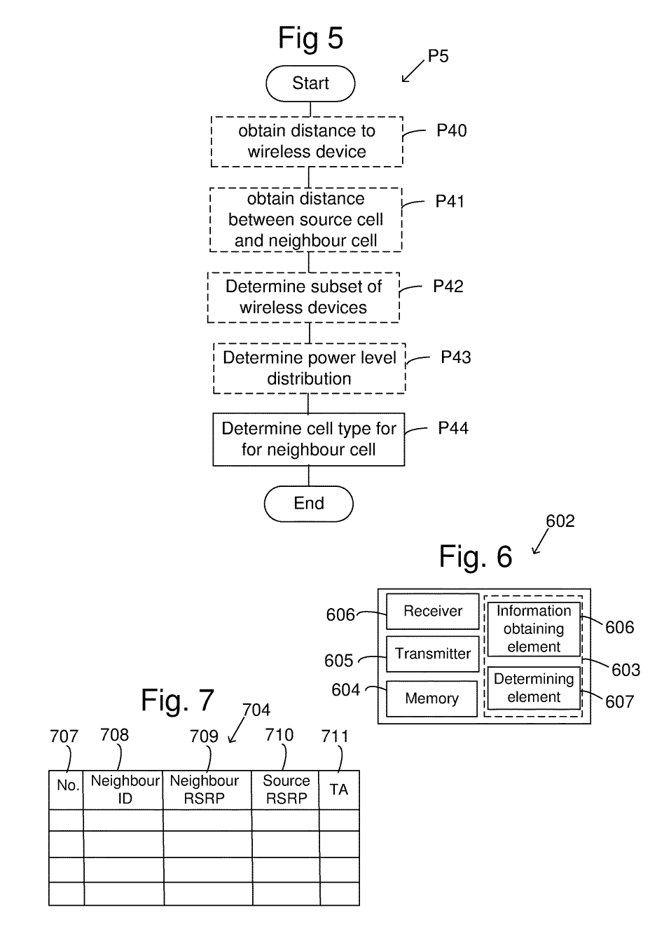

FIG. 5 illustrates a process for determining P5 whether at least one neighbour cell is a small cell based on obtained information related to a power level for a source cell and a power level for at least one neighbour cell. In one example, the obtained information also is related to a distance to the wireless device. In one example, the information related to the distance to the wireless device is a time advance, TA, value. A step of determining P44 whether one predetermined neighbour cell is a small cell is in one example based on a predetermined relation between the power levels for the predetermined neighbour cell and the power levels for the source cell.

If the information related to the source cell and the at least one neighbour cell comprises information related to a distance to the wireless device, this information is obtained in a step P40. The step of determining P44 whether one predetermined neighbour cell is a small cell is in one example based on the information related to the distance to the wireless device.

In one example, the process further comprises a step of obtaining P41 a distance between the neighbour cell and a centre of the source cell. The determining whether one predetermined neighbour cell is a small cell is in one example based on the information related to the distance between the neighbour cell and the centre of the source cell.

In one example, the information related to the distance between the neighbour cell and a centre of the source cell is determined based on the power level values for the source cell and/or the neighbour cell. In one example, the information related to the distance between the neighbour cell and a centre of the source cell is determined based on an average power level value for the source cell and/or the neighbour cell for the subset of wireless devices.

In one example, the step of obtaining P41 a distance between the neighbour cell and a centre of the source cell comprises determining a distance value for each of a plurality of wireless devices. The determination P44 of whether the at least one neighbour cell is a small cell is based on a spread in the distance values. In one example, a small cell is identified if the spread exceeds a predetermined value

In one example, the process comprises a step of determining P42 a subset of wireless devices for which a measure related to the power level for the at least one neighbour cell exceeds a predetermined value. The step of determining P42 a subset of wireless devices for which the measure related to the power level for the at least one neighbour cell exceeds a predetermined value comprises in one example identifying wireless devices for which the neighbour cell power level exceeds a threshold power level. The step of determining P42 a subset of wireless devices for which the measure related to the power level for the at least one neighbour cell exceeds a predetermined value comprises in one example identifying wireless devices for which the neighbour cell power level exceeds the power level of other neighbour cells, i.e. the neighbour cell is the strongest neighbour cell. The step of determining P44 whether the at least one neighbour cell is a small cell is then based on the power level distribution for the source cell and/or neighbour cell within the subset of wireless devices. In one example, the wireless devices are randomly selected.

In one example, the process comprises a step of determining P43 a power level distribution for the source cell and/or neighbour cell, and basing the determination P44 whether the at least one neighbour cell is a small cell on the power level distribution for the source cell and/or neighbour cell. In one example, the step of determining P44 whether the at least one neighbour cell is a small cell is based on a determination about whether the power level distribution for the source cell and/or neighbour cell is within a predetermined range. The predetermined range is in one example dependent on the information related to the distance between the neighbour cell and the centre of the source cell.

In FIG. 6, a network node 602 is arranged to classify a neighbour cell. The network node is in one example a EUTRA Node-B, eNB. The network node is in one example a Radio Network Controller, RNC.

The network node 602 comprises a receiver 606, a transmitter 605, a memory 604 and a control element 603. The control element 603 is arranged to determine whether a predetermined neighbour cell is a small cell, based on information obtained from a plurality of wireless devices. The information relates to a power level for the source cell and a power level for the at least one neighbour cell.

The receiver 606 is arranged to receive the information obtained from a plurality of wireless devices related to a source cell and at least one neighbour cell. The power level for at least one of the source cell and the at least one neighbour cell is in one example a Reference Signal Received Power, RSRP.

The memory 604 is arranged to store the information obtained from a plurality of wireless devices related to a source cell and at least one neighbour cell. The memory is in one example arranged to store software for determine whether the neighbour cell is a small cell or not.

The control element 603 is arranged to determine whether the neighbour cell is a small cell or not based on a relation between the power levels for the predetermined neighbour cell and the power levels for the source cell.

The control element comprises an information obtaining element 606 arranged to obtain, using the receiver, from a plurality of wireless devices information related to a power level of a neighbour cell and a power level of at least one neighbour cell. The control element further comprises a determining element 607 arranged to determine whether one of the at least one neighbour cells is a small cell, based on the information obtained by the information obtaining element

In FIG. 7, a memory 704 is arranged to store the information obtained from a plurality of wireless devices related to a source cell and at least one neighbour cell. The memory is arranged to store a plurality of measurements each identified with a number 707 or the like. For each measurement, at least one neighbour power level 709 and a source power level 710 is stored. Further, information related to a neighbour ID 708 is in one example stored. Further a distance value such as a time advance, TA, value 711 is in one example stored.

Even though the disclosure has been related to signalling in a EUTRAN, the methods of the disclosure herein can be implemented in other networks. For example, a Radio Network Controller, RNC, can be implemented with the method for classifying a neighbour cell.

In FIG. 2, examples of diagrams are illustrated, wherein it is assumed that a source cell 200 has a first neighbour 220 and a second neighbour 210. The first neighbour cell 220 is a small cell. The second cell 210 is a macro cell.

In the illustrated diagrams the upper diagram shows a power level curve 230 for the source cell 200 and a power level curve 240 for the small cell 220 as a function of the distance to a center of the source cell. The lower diagram shows the power level curve 230 for the source cell 200 and a power level curve 250 for the of the macro cell 210 as a function of the distance to a center of the source cell. In the illustrated example, there is one neighbor cell on each frequency each represented by one diagram of FIG. 2. However, in an alternative example, all neighbours are on the same frequency. In the illustrated example the power levels are Reference Symbol Received Power, RSRP.

In the illustrated example, a threshold power level is set. In one example, the threshold power level is set to a value larger than the minimum required received Reference Symbol Received Power (RSRP) level in the E-UTRA frequency for cell reselection. In the illustrated example, a poor coverage threshold is set. In one example, the poor coverage threshold is determined by A2 on source.

In the illustrated upper example, the power level of the small cell 220 exceeds the threshold power level within an interval i1. Within this interval the power levels of the source cell vary within a power level range Pₛ₁_{_}_{range}.

In the illustrated lower example, the power level of the macro cell 210 exceeds the threshold power level within an interval i2. Within this interval, the power levels of the source cell vary within a power level range Pₛ₂_{_}_{range}.

Since the small cell's coverage range is expected to be considerably smaller than that of macro cells, it is expected that a set of UEs which all report the same neighboring cell as strongest cell, will measure a smaller range of RSRP values for their source cell, if the strongest neighboring cell is a small cell compared to it being a macro cell. In one example, the RSRP range of the source cell corresponding to each neighbor is used for identifying those neighbor small cells.

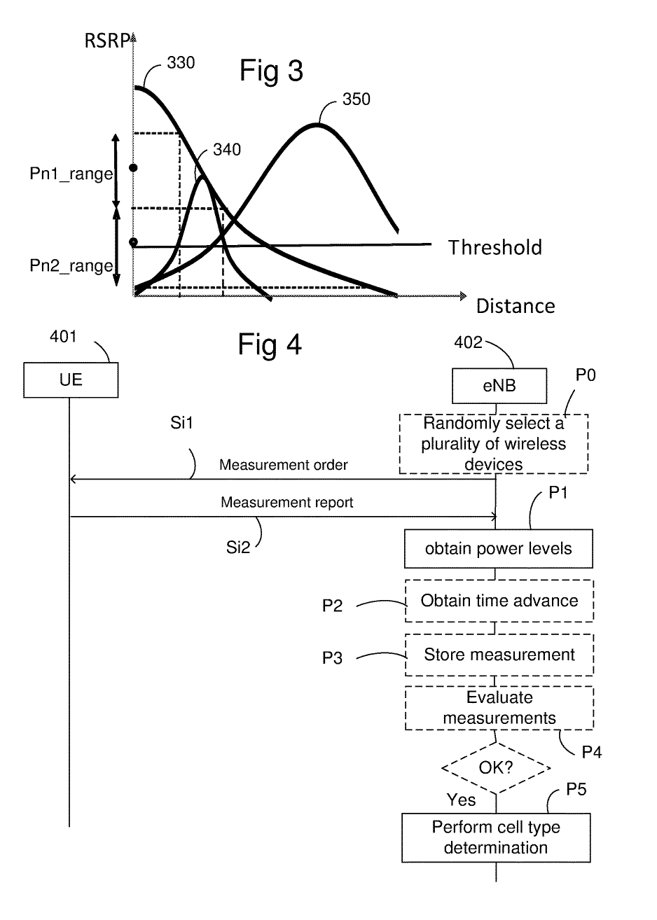

In FIG. 3, an example of a diagram is illustrated, wherein it is assumed that a source cell has a first neighbour and a second neighbour. The first neighbour cell is a small cell. The second cell is a macro cell.

In the illustrated diagram, a power level curve 330 for the source cell, a power level curve 340 for the small cell and a power level curve 350 for the macro cell are illustrated as a function of the distance to a center of the source cell.

In the illustrated example, there is one neighbor frequency and the two neighbor cells are on that frequency. However, in an alternative example, the neighbour cells are on different frequencies.

In the scenario of FIG. 3, the small cell is closer to the source cell's center than in the example of FIG. 2. Then, the power level range of the source cell, when the small cell is the strongest neighbor cell, may be very large. This is a result of the fact that the path loss has not a linear relation to distance.

For macro cell in urban and suburban area the path loss can be calculated as

L=40·(1−4·10⁻³·Dhb)·log₁₀(R)−18·log₁₀(Dhb)+21·log₁₀(f)+80 dB

where L is the path loss and R is the distance between the eNB and UE.

In this scenario, one proposal is to correlate a power level range, wherein the respective neighbour cell is the strongest neighbour cell, to an average value or the like of the source RSRP in this range. In the illustrated example, the small cell with the power level curve 340 is the strongest neighbour cell in a first power level range Pₙ₁_{_}_{range}. Further the macro cell with the power level curve 350 is the strongest neighbour cell in a second power level range Pₙ₂_{_}_{range}.

The average value is depicted as bold circles on the y-axis of the diagram in FIG. 3. This average value or the like identifies where in the source cell the specific neighbor is located, i.e. whether it is close to the center or close to the border. Depending on this information the expected power level ranges for small cells and macros are different. An algorithm is in one example used for correlating a power level range, wherein a predetermined neighbour cell is a strongest neighbour cell with the average value or the like to identify if the neighbour is a small cell or not. In one example, any identified neighbor cell close to the border is excluded as a candidate small cell in order to avoid miss-interpreting a neighbor macro cell with a very little coverage overlap with the source cell, as a small cell. Table below is a simple example for correlating the indices mentioned above to identify target pico cells.

| RSRP zones | 1 | 2 | 3 | 4 |
|---|---|---|---|---|
| [dBm] | −50 to −63 | −63 to −75 | −78 to −87 | −87 to −180 |
| Expected source RSRP | 20-30 dB | 15-20 dB | 10-15 dB | 5-10 dB |
| range corresponding to a | | | | |
| neighbour small cell | | | | |

Another possibility for solving this scenario is to use the measured power levels from both source and at least one neighbour cell. The relation between the source cell power level and the neighbour cell power level is different depending on cell type in a case that is similar to the situation from FIG. 3.

It is also possible to use other available information such as timing advance, TA, and/or the neighbor cells RSRP range and combine them with the RSRP range in the source cell to identify the small cells.

The timing advance, TA, holds information about the distance between the source cell antenna and the individual UE. For a small neighbor cell, the TA range is characteristically smaller than for a macro cell. A small cell is only the strongest neighbor cell for a short TA range, while a macro cell is strongest for a longer TA value range.

There is also a possibility to use the absolute power level range as an indicator on the distance from cell antenna. The power level range on the source cell is practically the same for both the small cell and the macro cell. However the path loss from the source represents a smaller distance, which can be identified using the absolute power level from the source cell.

Different combinations of measured power level values from the source cell, measured power level values from the neighbour cell(s) and TA values can be used to identify small cells. The power level values can be used both in relation to each other but also as absolute values.

1. A method performed in a network node of classifying a neighbour cell, comprising the steps of:
obtaining, from a plurality of wireless devices, information related to a power level of source cell and information related to a power level of a neighbour cell, and
determining, based on the obtained information, whether the neighbour cell is a small cell.

2. The method according to claim 1, wherein the power level for the source cell and the neighbour cell is a Reference Signal Received Power (RSRP).

3. The method according to claim 1, wherein the step of determining whether the neighbour cell is a small cell comprises determining a relation between the obtained power levels for the neighbour cell and the power levels for the source cell.

4. The method according to claim 1, wherein the method further comprises:
determining a power level distribution for one or more of: the source cell and the neighbour cell, and basing the deteimination whether the neighbour cell is a small cell on the determined power level distribution(s).

5. The method according to claim 1, further comprising the step of:
determining a subset of wireless devices for which a measure related to the power level for the neighbour cell exceeds a predetermined value and
basing the determination of whether the neighbour cell is a small cell on the power level distribution for the source cell and/or the neighbour cell within the subset of wireless devices.

6. The method according to claim 5, wherein the step of determining a subset of wireless devices for which the measure related to the power level for the neighbour cell exceeds a predetermined value comprises identifying wireless devices for which the neighbour cell power level exceeds the predetermined value.

7. The method according to claim 4, wherein the determination of whether the neighbour cell is a small cell is based on a determination whether the power level distribution for the source cell and/or neighbour cell is within a predetermined range.

8. The method according to claim 1, further comprising the step of: obtaining a distance between the neighbour cell and a centre of the source cell wherein the determination whether one predetermined neighbour cell is a small cell is based on information related to the distance between the neighbour cell and the centre of the source cell.

9. The method according to claim 7, further comprising
obtaining a distance between the neighbour cell and a centre of the source cell, wherein
the determination whether one predetermined neighbour cell is a small cell or not is based on information related to the determined distance between the, neighbour cell and a centre of the. source cell and wherein the predetermined range is dependent on the information related to the distance between the neighbour cell and the centre of the source cell.

10. The method according to claim 8, wherein the information related to the distance between the neighbour cell and a centre of the source cell is based on the power level values for the source cell and/or the neighbour cell.

11. The method according to claim 10, wherein the information related to the distance between the neighbour cell and a centre of the source cell is based on an average power level value for the source cell and/or the neighbour cell for the subset of wireless devices.

12. The method according to claim 8, wherein the step of obtaining a distance between the neighbour cell and a centre of the source cell comprises determining a distance value for each of a plurality of wireless devices and basing the determination of whether the neighbour cell is a small cell on a spread in the distance values.

13. The method according to claim 1, wherein the step of obtaining information related to the source cell and the neighbour cell comprises obtaining from the plurality of wireless devices information related to a distance to the wireless device, wherein the step of determining whether one predetermined neighbour cell is a small cell is based on the obtained information related to the distance to the wireless device.

14. The method according to claim 13, wherein the information related to the distance to the wireless device is a time advance, TA, value.

15. The method according claim 1, wherein the step of determining whether one predetermined neighbour cell is a small cell is initiated upon obtaining, from a predetermined number of wireless devices, the information related to the source cell and to the neighbour cell.

16. The method according to claim 1, further comprising a step of evaluating the obtained information related to the source cell and to the neighbour cell, wherein the step of determining whether one predetermined neighbour cell is a small cell is initiated if the evaluation indicates that a certain amount of information for determining whether one predetermined neighbour cell is a small cell has been obtained.

17. The method according to claim 1, further comprising a step of storing the obtained information in a memory.

18. A network node arranged to classify a neighbour cell, said network node comprising a receiver and a control element, wherein the network node is configured to:
obtain, using the receiver, from a plurality of wireless devices, information related to a power level of a source cell and a power level of a neighbour cell, and
determine, based on the obtained information, whether one of the neighbour cell is a small cell

19. The network node according to claim 18, wherein the power level for at least one of the source cell and the neighbour cell is a Reference Signal Received Power (RSRP).

20. The network node according to claim 18, wherein the network node is arranged to determine whether the neighbour cell is a small cell or not based on a relation between the power levels for the neighbour cell and the power levels for the source cell.

21. The network node-according to claim 18, wherein the receiver is arranged to receive the information obtained from a plurality of wireless devices related to a source cell and the neighbour cell.

22. The network node according to claim 18, wherein the memory is arranged to store the information obtained from a plurality of wireless devices related to a source cell and the neighbour cell.

23. The network node according to claim 18, wherein the network node is a EUTRA ENode-B.

24. The network node according to claim 18, wherein the network node is a Radio Network Controller.

25. A computer program product comprising a non-transitory computer readable medium storing a computer program for performing the method of claim 1.
